(19) United States
(12) Patent Application Publication
(10) Pub. No.: US 2026/0214719 A1
(43) Pub. Date: Jul. 23, 2026

(54) METHOD AND APPARATUS FOR SCHEDULING REQUEST FOR NETWORK ENERGY SAVING IN WIRELESS COMMUNICATION SYSTEM

(71) Applicant: Samsung Electronics Co., Ltd., Suwon-si, Gyeonggi-do (KR)

(72) Inventors: Vinay Kumar SHRIVASTAVA, Bangalore (IN); Sangkyu BAEK, Suwon-si (KR); Aby Kanneath ABRAHAM, Bangalore (IN); Sriganesh RAJENDRAN, Bangalore (IN); Anil AGIWAL, Mountain View, CA (US)

(21) Appl. No.: 19/140,758

(22) PCT Filed: Mar. 15, 2024
(86) PCT No.: PCT/KR2024/095578

§ 371 Date: Jun. 18, 2025

(30) Foreign Application Priority Data
Mar. 21, 2023 (IN) 202341019502
Mar. 7, 2024 (IN) 2023 41019502

(51) Int. Cl. H04W 74/0833

(52) U.S. Cl. CPC H04W 74/0833

(57) ABSTRACT

The disclosure relates to a 5G or 6G communication system for supporting a higher data transmission rate. Embodiments herein disclose methods and systems for configuring Scheduling Requests (SR) for Network Energy Saving (NES), wherein existing SR procedures for the UE are enhanced to enable a graceful co-existence with NES approaches as employed by the network nodes. Embodiments herein disclose methods and systems for enabling a UE to initiate transmission of the SR, if the UE is not in a non-active period of at least one configured and activated cell-DRX configuration in a serving cell.

### TECHNICAL FIELD

Embodiments disclosed herein relate to wireless communication system (or mobile communication system). More particularly, the disclosure relates to enhanced methods and systems for configuring Scheduling Requests (SR) for Network Energy Saving (NES).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Network Energy Saving (NES) has become one of the most significant aspects recently considering the ever-increasing power consumption by wireless networks that serve User Equipments (UEs), and the associated high cost involved. Towards enabling energy efficiency for networks operations, more particularly, for the transmission and the reception by the Radio Access Network (RAN) nodes that account for 22% of the overall power consumption by the communication networks, there is a need for efficient approaches that can achieve energy savings for the networks. Some of these approaches may include special operation modes (for example, a NES mode), wherein the network nodes may apply discontinuous transmission (DTX) and/or discontinuous reception (DRX) to curtail power consumption by the nodes.

One potential issue with the NES approaches could be a potential conflict or ambiguity for the Scheduling Request (SR) procedure of the UE, when operating with the radio cell/network node that employs NES. SR procedure for the UE is based on the uplink data arrival and is quite independent of the network state. As a result, there is a need to enhance the existing SR procedures for the UE to enable a graceful co-existence with NES approaches as employed by the network nodes.

Hence, there is a need in the art for solutions which will overcome the above mentioned drawback(s), among others.

The principal object of embodiments herein is to disclose methods and systems for configuring Scheduling Requests (SR) for Network Energy Saving (NES), wherein existing SR procedures for the UE are enhanced to enable a graceful co-existence with NES approaches as employed by the network nodes.

Another object of embodiments herein is to disclose methods and systems for enabling a UE to initiate transmission of the SR, if the UE is not in a non-active period of at least one configured and activated cell-DRX configuration in a serving cell.

### Solution to Problem

According to an embodiment of the disclosure, a method performed by a terminal is provided. The method comprises: identifying that a cell discontinuous reception (DRX) is configured and is activated for a serving cell; and identifying whether the serving cell is in a cell DRX non-active period, wherein, in case that the serving cell is in the cell DRX non-active period, a scheduling request (SR) is not transmitted, an SR counter is not incremented, and an SR prohibit timer is not started

According to an embodiment of the disclosure, a terminal is provided. The terminal comprises: a transceiver; and a controller coupled with the transceiver and configured to: identify that a cell discontinuous reception (DRX) is configured and is activated for a serving cell, and identify whether the serving cell is in a cell DRX non-active period, wherein, in case that the serving cell is in the cell DRX non-active period, a scheduling request (SR) is not transmitted, an SR counter is not incremented, and an SR prohibit timer is not started.

Accordingly, the embodiments herein provide a method for configuring scheduling requests (SR) for Network Energy Savings (NES) in a wireless communication network. The method comprises a User Equipment (UE) initiating transmission of the SR, if the UE is not in a non-active period of at least one configured and activated cell-DRX configuration in a serving cell.

Accordingly, the embodiments herein provide a User Equipment (UE), wherein the UE comprises a processor; a memory; and a communication module. The processor is coupled with the memory, and the communication module, and is configured to initiate transmission of scheduling requests (SR) for Network Energy Savings (NES) in a serving cell, if the UE is not in a non-active period of a configured and activated cell-DRX configuration.

These and other aspects of the embodiments herein will be better appreciated and understood when considered in conjunction with the following description and the accompanying drawings. It should be understood, however, that the following de-scriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to various embodiments of the disclosure, SR related procedures can be efficiently enhanced in a cell or network node employing NES.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a wireless communication network, according to embodiments as disclosed herein;

FIG. 2 depicts the method to transmit the scheduling request for NES, according to embodiments as disclosed herein;

FIG. 3 depicts the method to configure the scheduling request and/or Random Access procedure for NES, according to embodiments as disclosed herein;

FIG. 4 depicts the method to transmit the scheduling request for NES, according to embodiments as disclosed herein;

FIG. 5 depicts the method to configure for Random Access triggering for NES, according to embodiments as disclosed herein;

FIG. 6 depicts the method to configure for Random Access triggering for NES, according to embodiments as disclosed herein;

FIG. 7 is a block diagram showing a structure of a terminal according to an embodiment of the disclosure; and

FIG. 8 is a block diagram showing a structure of a base station according to an embodiment of the disclosure.

### MODE FOR THE INVENTION

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommu-nications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, embodiments of the disclosure will be described in detail with reference to the accompanying drawings. It should be noted that the same reference numerals in different drawings will be used to refer to the same elements already described.

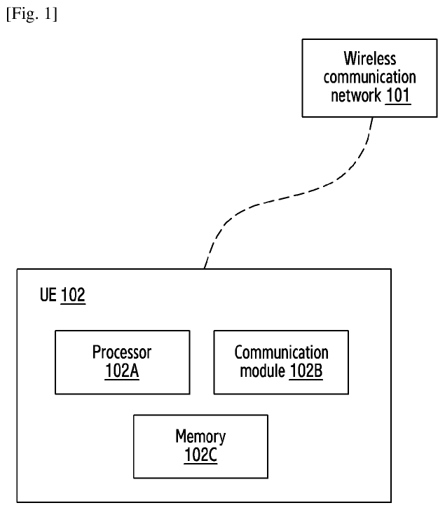

The embodiments herein achieve methods and systems for configuring Scheduling Requests (SR) for Network Energy Saving (NES), wherein existing SR procedures for the UE are enhanced to enable a graceful co-existence with NES approaches as employed by the network nodes. Referring now to the drawings, and more particularly to FIGS. 1 through 6, where similar reference characters denote corresponding features consistently throughout the figures, there are shown embodiments.

FIG. 1 depicts a wireless communication network. The wireless communication network 101 can be connected to at least one User Equipment (UE) 102. The UE 102, as depicted, comprises a processor 102A, a communication module 102B, and a memory 102C. The processor 102A can further comprise one or more MAC entities (not shown).

The processor 102A may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 102A may include multiple cores and is configured to execute the instructions stored in the memory 102C.

Further, the processor 102A is configured to execute instructions stored in the memory 102C and to perform various processes. The communication module 102B is configured for communicating internally between internal hardware components and with external devices via one or more networks. The memory 102C also stores instructions to be executed by the processor 102A. The memory 102C may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 102C may, in some examples, be considered a non-transitory storage medium. The term “non-transitory” may indicate that the storage medium is not embodied in a carrier wave or a propagated signal. However, the term “non-transitory” should not be interpreted that the memory 102C is non-movable. In certain examples, a non-transitory storage medium may store data that can, over time, change (e.g., in Random Access Memory (RAM) or cache).

In an embodiment herein, the communication module 102B includes an electronic circuit specific to a standard that enables wired or wireless communication. The communication module 102B is configured to communicate internally between internal hardware components of the UE 102 and with external devices via one or more networks.

Consider a scenario where the UE 102 is not in a non-active period of a configured and activated cell-DRX configuration, the processor 102A can initiate transmission of a scheduling request (SR) for Network Energy Savings (NES) in the serving cell. In an embodiment herein, the processor 102A does not transmit the SR, if the UE is in the non-active period of the configured and activated cell-DRX configuration. In an embodiment herein, on the UE coming out of the non-active period of the configured and activated cell-DRX configuration, the processor 102A can transmit the SR in a valid Physical Uplink Control Channel (PUCCH). The processor 102A can transmit one of the SR, or a pertinent Random Access (RA), if the UE is in the non-active period of the configured and activated cell-DRX configuration, based on one or more parameters. Examples of the parameters can be, but not limited to, type of the SR; priority of a service to which the SR corresponds; latency of the service; criticality of service; and priority of at least one of a Logical channel Group (LCG), a Logical Channel, and a SR configuration to which the SR corresponds. The processor 102A can determine that the SR can be transmitted, or that the RA can be triggered in the non-active period of the configured and activated cell-DRX configuration, if configured for the UE 102 in at least one of a Radio Resource Control (RRC) signalling by the wireless communication network for a specific SR configuration; a flag as part of a System information message; and implicitly indicating by the NES mode indication as part of a system information message. In another embodiment herein, the UE 102 can be configured in at least one of a common L1/L2 signaling, and a Medium Access Control (MAC) Control Element (CE). In an embodiment, on receiving an indication from the wireless communication network in at least one of a group common Downlink Control Information (DCI) signaling, and a Medium Access Control (MAC) Control Element (CE), the processor 102A can activate and/or deactivate at least one cell-DRX configuration, and at least one cell-DTX configuration. In an embodiment herein, the NES mode indication comprises at least one of a full sleep state with no transmission and reception during the non-active period of the configured and activated cell-DRX configuration, a partial sleep state supporting only uplink or downlink, and a partial sleep state with supporting RA/SR access only. If there is no valid Physical Uplink Control Channel (PUCCH) configured for the SR, and the UE 102 is in the non-active period of the configured and activated cell-DRX configuration, the processor 102A can initiate a RA procedure on a SpCell, and cancel a pending SR, on initiating the RA procedure. If a service to which the RA, or pertinent SR corresponds is an emergency service, the processor 102A can trigger the RA, irrespective of the active period, or the non-active period of the configured and activated cell-DRX configuration.

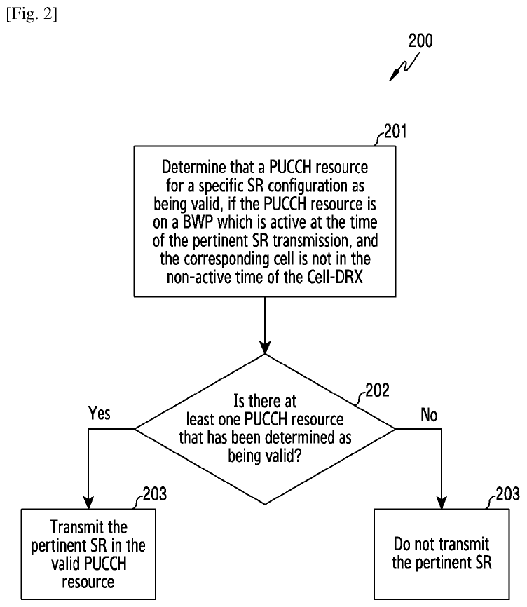

In an embodiment herein, the processor 102A can consider only PUCCH resources on a BWP, which is active at the period of SR transmission pertaining to relevant SR configuration, as being valid. The processor 102A can consider the BWP as being inactive during the period when the cell to which BWP corresponds, is in the non-active period of the Cell-DRX. Further, the processor 102A can consider the BWP as active (or is activated), when the cell to which BWP corresponds comes out of non-active period of the Cell-DRX (as illustrated in FIG. 2).

In step 201, the UE 102 determines that a PUCCH resource for a specific SR configuration as being valid, if the PUCCH resource is on a BWP which is active at the period of the pertinent SR transmission, and the corresponding cell is not in the non-active period of the Cell-DRX. In step 202, the UE 102 checks if there is at least one PUCCH resource that has been determined as being valid. If there is at least one PUCCH resource that has been determined as being valid, in step 203, the UE 102 transmits the pertinent SR in the valid PUCCH resource. If there are no PUCCH resource(s) that have been determined as being valid, in step 204, the UE 102 does not transmit the pertinent SR. The various actions in method 200 may be performed in the order presented, in a different order or simultaneously. Further, in some embodiments, some actions listed in FIG. 2 may be omitted.

In an embodiment herein, only PUCCH resources on a BWP, which is active and the corresponding cell is not in a non-active period of the Cell-DRX and/or not in a non-active period of the Cell-DTX at the period of SR transmission pertaining to relevant SR configuration, are considered valid by the processor 102A; i.e., PUCCH resources on a BWP, which is not active or the corresponding cell is in not in Active period of the Cell-DRX at the period of SR transmission, are considered invalid by the processor 102A, and SR transmission is not pursued.

In an embodiment herein, for a specific SR configuration, only those PUCCH resources for BWP(s) and cell(s) are considered by the processor 102A for SR transmission, wherein the cell(s) are not in non-active period of the Cell-DRX at the period of SR transmission.

In an embodiment herein, for a SR configuration, the processor 102A determines the valid PUCCH resource(s) and the invalid PUCCH resource(s) based on the Active period of the Cell-DRX of the pertinent cell(s) at the period of SR transmission pertaining to relevant SR configuration and considers SR transmission on at least one of the valid PUCCH resource.

In an embodiment herein, if a SR is not transmitted due to the corresponding cell(s) being in the non-active period of the Cell-DRX, the processor 102A keeps the SR as pending (i.e., SR is not cancelled). The processor 102A keeps the SR_COUNTER intact (i.e. not incremented or not reset), and keeps the sr-ProhibitTimer intact (i.e. remains stopped or remains running).

In an embodiment herein, the processor 102A may allow a specific SR and/or pertinent Random Access (RA) to be transmitted, inspite of the corresponding cell(s) being in the non-active time of the Cell-DRX.

In an embodiment herein, the processor 102A may selectively allow/not allow a SR and/or pertinent RA to be transmitted when the corresponding cell(s) is being in the non-active period of the Cell-DRX. The selectivity can be based on the at least one of type of SR, priority of the service, latency of the service, criticality of service, priority of the Logical channel Group (LCG) or Logical Channel or Scheduling Request configuration to which the SR corresponds. For example, one relevant service may be an emergency service. The type of SR may be at least one of SR configuration corresponding to one or more logical channels and/or to SCell beam failure recovery and/or to consistent LBT failure recovery and/or to beam failure recovery of a BFD-RS set and/or to positioning measurement gap activation/deactivation request. The SR configuration of the logical channel that triggered a Buffer Status Report (BSR) or the SCell beam failure recovery, or the beam failure recovery of a BFD-RS set, or the consistent LBT failure recovery or positioning measurement gap activation/deactivation request is considered as corresponding SR configuration for the triggered SR. Any SR configuration may be used by the processor 102A for an SR triggered by Pre-emptive BSR or Timing Advance reporting.

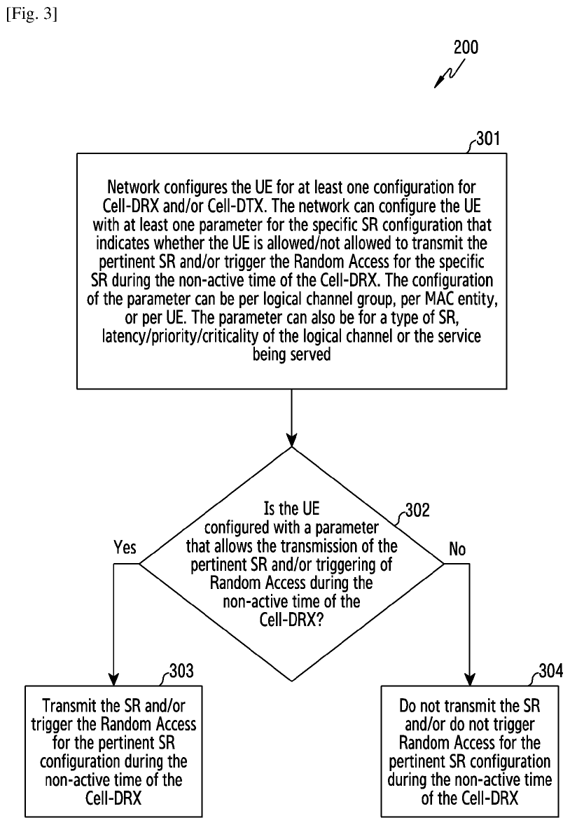

In an embodiment herein, the network 101 can configure the UE in the RRC signalling for at least one of the SR configuration and/or pertinent RA, if the pertinent SR transmission and/or pertinent RA triggering is allowed or not allowed in the non-active period of the Cell-DRX of the NES cell (as illustrated in FIG. 3).

In step 301, the network 101 configures the UE 102 for at least one configuration for Cell-DRX (and/or Cell-DTX). The network 101 can configure the UE 102 with at least one parameter for the specific SR configuration that indicates whether the UE 102 is allowed/not allowed to transmit the pertinent SR and/or trigger the Random Access for the specific SR during the non-active period of the Cell-DRX. The configuration of the parameter can be per logical channel group, per MAC entity, or per UE. The parameter can also be for a type of SR, latency/priority/criticality of the logical channel or the service being served. For example, one relevant service may be an emergency service. In step 302, the processor 102A checks if the UE 102 is configured with a parameter that allows the transmission of the pertinent SR and/or triggering of Random Access during the non-active period of the Cell-DRX. If the UE 102 is configured with a parameter that allows the transmission of the pertinent SR and/or triggering of Random Access during the non-active period of the Cell-DRX, in step 303, the processor 102A transmits the SR and/or triggers the Random Access for the pertinent SR configuration during the non-active period of the Cell-DRX. If the UE 102 is not configured with a parameter that allows the transmission of the pertinent SR and/or triggering of Random Access during the non-active period of the Cell-DRX, in step 304, the processor 102A does not transmit the SR and/or does not trigger Random Access for the pertinent SR configuration during the non-active period of the Cell-DRX. The various actions in method 300 may be performed in the order presented, in a different order or simultaneously. Further, in some embodiments, some actions listed in FIG. 3 may be omitted.

In an embodiment herein, the network 101 can specify (e.g. 3GPP specification) for the UE 102 in the RRC signalling work for a specific SR configuration, if the pertinent SR transmission is allowed or not allowed in the non-active period of the Cell-DRX of the NES cell.

In an embodiment herein, based on the UE implementation, the processor 102A can determine if the pertinent SR transmission for a specific SR configuration and/or pertinent RA is allowed or not allowed in the non-active period of the Cell-DRX of the NES cell. The determining factors may include at least one of the priority of servcie, priority of the logical channel, latency of the service, criticality of the service and the type of SR for the corresponding triggered SR. For example, one relevant service may be an emergency service.

In an embodiment herein, as long as at least one SR is pending, if the MAC entity has no valid PUCCH resource configured for the pending SR and if the corresponding cell (e.g., SpCell) is not in non-active period of the Cell-DRX, the processor 102A can initiate a Random Access procedure on the SpCell, and cancel the pending SR, for each pending SR. The SpCell includes a primary cell of Master Cell Group (PCell) and a primary cell of Secondary cell Group (PSCell).

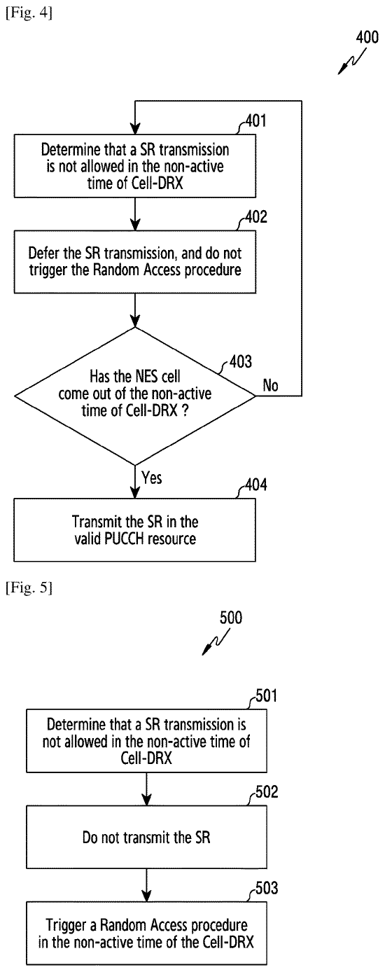

In an embodiment herein, as long as at least one SR is pending, the MAC entity shall for each pending SR, if the MAC entity has no valid PUCCH resource configured for the pending SR and if the corresponding cell (e.g. SpCell) is in non-active period of the Cell-DRX X, the MAC entity does not initiate a Random Access procedure on the SpCell and keeps the SR pending. Once the UE comes out of non-active period of the Cell-DRX, the UE triggers the SR transmission (as illustrated in FIG. 4).

Consider that the UE 102 is in the non-active period of the Cell-DRX of the NES cell. In step 401, the processor 102A determines that a SR transmission is not allowed in the non-active period of Cell-DRX (for example, due to configuration restriction, no valid PUCCH resource availability). In step 402, the processor 102A defers the SR transmission, and does not trigger the Random Access procedure, as SR transmission is not allowed in the non-active period of Cell-DRX. If the NES cell has come out of the non-active period of Cell-DRX (step 403), in step 404, the processor 102A transmits the SR in the valid PUCCH resource. If the NES cell has not come out of the non-active period of Cell-DRX (step 403), the processor 102A proceeds with step 401. The various actions in method 400 may be performed in the order presented, in a different order or simultaneously. Further, in some embodiments, some actions listed in FIG. 4 may be omitted.

In an embodiment herein, as long as at least one SR is pending, if the MAC entity has no valid PUCCH resource configured for the pending SR and if the corresponding cell (e.g. SpCell) is in non-active period of the Cell-DRX, the processor 102A can initiate a Random Access procedure on the SpCell and cancel the pending SR, for each pending SR (as illustrated in FIG. 5).

Consider that the UE 102 is in the non-active period of the Cell-DRX. In step 501, the processor 102A determines that a SR transmission is not allowed in the non-active period of Cell-DRX (for example, due to configuration restriction, no valid PUCCH resource availability). In step 502, the processor 102A does not transmit the SR, as SR transmission is not allowed in the non-active period of Cell-DRX. In step 503, the processor 102A triggers a Random Access procedure in the non-active period of the Cell-DRX. The various actions in method 500 may be performed in the order presented, in a different order or simultaneously. Further, in some embodiments, some actions listed in FIG. 5 may be omitted.

In an embodiment herein, the network 101 configures the UE 102 for at least one of the Scheduling Request (SR) configuration through a RRC signaling message for operation over at least one of the BWP(s) and/or NES cell(s). The configuration of the at least one SR may comprise one or more parameters that govern the behavior for the UE whether the pertinent SR transmission and/or pertinent RA is allowed or not allowed when the relevant cell(s) for which and/or on which SR transmission and/or RA triggering is pursued is in the non-active period of the Cell DRX for one or more NES Cell DRX configuration(s). The configuration may be per SR configuration and controls the behavior for each specific SR configuration and/or pertinent RA.

In an embodiment herein, one or more NES Cell DRX and/or Cell DTX configurations that are considered pertinent to the activated configuration; i.e., deactivated NES Cell DRX and/or Cell DTX configurations are not considered, while deciding about the SR transmissions. In an embodiment herein, at least one of the Cell-DRX configuration and/or Cell-DTX configuration for the NES Cell is in activated state when the relevant configuration is configured for the UE 102 by the network 101 and/or the relevant configuration is explicitly indicated as activated in a common L1/L2 signaling (e.g. group common downlink control information, DCI) and/or Medium Access Control (MAC) Control Element (CE) signaling to the UE 102 with at least one of a bit, bitmap, code-point or index. In an embodiment herein, there can be more than one activated Cell-DRX configuration. In an embodiment herein, at least one of the Cell-DRX configuration and/or Cell-DTX configuration for the NES cell is in the deactivated state when the relevant configuration is released for the UE 102 by the network 101 and/or the relevant configuration is explicitly indicated as deactivated in a common L1/L2 signaling (e.g. group common downlink control information, DCI) and/or Medium Access Control (MAC) Control Element (CE) signaling to the UE 102 with at least one of a bit, bitmap, code-point or index.

In an embodiment herein, the SR configuration parameter(s) or field(s) configured for the one or more SR configuration for the UE 102 governs at least one of the following behavior for the pertinent SR transmission for the NES cell(s):
a) The parameter indicates that SR transmission is allowed for the pertinent SR configuration in the non-active period of the Cell DRX on the NES cell.
b) The parameter indicates that SR transmission is not allowed for the pertinent SR configuration in the non-active period of the Cell DRX on the NES cell.

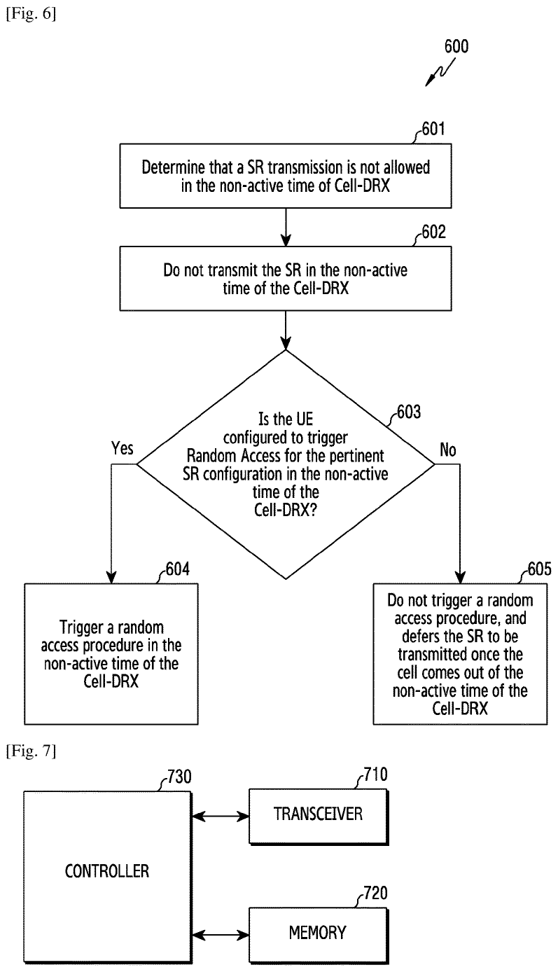

In an embodiment herein, if the SR transmission is not allowed for the pertinent SR configuration in the non-active period of the Cell DRX on the NES cell and/or no availability of the PUCCH resources, then at least one parameter(s) or field(s) configured for the one or more SR configuration for the UE 102 governs at least one of the following behavior for the Random Access (RA) triggering and preamble transmission due to specific SR triggering on the NES cell(s) (as illustrated in FIG. 6):
a) The parameter indicates that RA triggering and preamble transmission is allowed, that is triggered due to the pertinent SR in the non-active period of the Cell DRX on the NES cell and/or no availability of valid PUCCH resource for SR transmission.
b) The parameter indicates that RA triggering and preamble transmission is not allowed, that is triggered due to the pertinent SR in the non-active period of the Cell DRX on the NES cell and/or no availability of valid PUCCH resource for SR transmission.
c) The parameter indicates that RA triggering and preamble transmission is allowed that is triggered due to the pertinent SR in the non-active period of the Cell DRX on the NES cell, only if the remaining period until the next valid PUCCH occasion for the SR is longer than T (considering delay requirement), the UE triggers a Random Access. Time threshold T can be configured by an RRC signaling message from the network.
d) The parameter indicates that RA triggering and preamble transmission is selectively allowed or not allowed, that is triggered due to the specific SR in the non-active period of the Cell DRX on the NES cell and/or no availability of valid PUCCH resource for specific SR transmission.

Consider that the UE 102 is in the non-active period of the Cell-DRX of the NES cell. In step 601, the processor 102A determines that a SR transmission is not allowed in the non-active period of Cell-DRX (for example, due to configuration restriction, no valid PUCCH resource availability). In step 602, the processor 102A does not transmit the SR in the non-active period of the Cell-DRX. In step 603, the processor 102A checks if the UE 102 is configured to trigger Random Access for the pertinent SR configuration in the non-active period of the Cell-DRX. If the UE 102 is configured to trigger Random Access for the pertinent SR configuration in the non-active period of the Cell-DRX, in step 604, the processor 102A triggers a Random Access procedure in the non-active period of the Cell-DRX. If the UE 102 is not configured to trigger Random Access for the pertinent SR configuration in the non-active period of the Cell-DRX, in step 605, the processor 102A does not trigger a Random Access procedure, and defers the SR to be transmitted once the cell comes out of the non-active period of the Cell-DRX. The various actions in method 600 may be performed in the order presented, in a different order or simultaneously. Further, in some embodiments, some actions listed in FIG. 6 may be omitted.

In an embodiment herein, the Random Access (RA) triggering and preamble transmission which is due to SR triggering on the NES cell(s), can be allowed or not allowed selectively for the specific SR. This is configured for the pertinent SR configuration by the network 101 in the RRC signaling. In an embodiment herein, it is specified (e.g., in the 3GPP specifications) by the network 101, as to which SR types, the corresponding RA triggering and preamble transmission is allowed or not allowed. The SR types includes at least one of SR configuration corresponding to one or more logical channels and/or to SCell beam failure recovery and/or to consistent LBT failure recovery and/or to beam failure recovery of a BFD-RS set and/or to positioning measurement gap activation/deactivation request. The SR configuration of the logical channel that triggered a BSR or the SCell beam failure recovery, or the beam failure recovery of a BFD-RS set, or the consistent LBT failure recovery or positioning measurement gap activation/deactivation request can be considered as a corresponding SR configuration for the triggered SR. Any SR configuration may be used by the processor 102A for an SR triggered by Pre-emptive BSR or Timing Advance reporting.

In an embodiment herein, if the SR is kept pending (due to the pertinent SR being triggered in the non-active period of the Cell DRX on the NES cell), the SR is re-triggered when the NES cell comes out of the non-active period of the Cell DRX. The processor 102A can transmit the triggered SR in a valid PUCCH resource in the active period of the Cell DRX. If the triggered SR could not be transmitted due to a valid PUCCH resource is not available, the processor 102A can trigger a Random Access (RA) preamble transmission.

In an embodiment herein, the msg1 and/or msg3 contents (e.g., control elements BSR, PHR) are updated by the processor 102A, if they were already included earlier in msg1 and/or msg3, and transmitted in the Random Access procedure which was triggered due to a pending SR after the NES cell comes out of the non-active period of the Cell DRX.

In an embodiment herein, consider that the msg1 and/or msg3 contents are updated to include control elements (e.g., BSR, PHR), if they were not already included earlier in msg1 and/or msg3, and transmitted in the Random Access procedure which is triggered due to pending SR after the NES cell comes out of the non-active period of the Cell DRX. For this purpose, the processor 102A can trigger a new BSR and/or PHR at the time of Random Access procedure which has been triggered due to a pending SR after the NES cell comes out of the non-active period of the Cell DRX.

In an embodiment herein, a base station (for e.g., gNB in NR) in the network 101 (not shown) configures the radio resources for SR or Random Access for SR in the UE 102, which could be allowed during the non-active period of the Cell-DRX continuously in the frequency domain. In an embodiment herein, the base station can configure the UE 102 which is not capable of supporting Cell-DRX (and/or Cell-DTX) with resources for SR and Random Access for SR only within this continuous frequency.

In an embodiment herein, a base station (for e.g., gNB in NR) configures the radio resources for SR or Random Access for SR in the UE 102 which could be allowed during the non-active period of the Cell-DRX continuously in time domain. In an embodiment herein, the base station can configure the UE 102 which is not capable of supporting Cell-DRX (and/or Cell-DTX) with resources for SR and Random Access for SR only within this continuous period. In an embodiment herein, the base station can inform the UE 102 that these time domain resources where SR could be performed during the non-active period of the Cell-DRX.

In an embodiment herein, a base station informs the UE 102 about the frequencies, where the SR or Random Access for SR could be performed during the non-active period of the Cell-DRX. In an embodiment herein, the informed frequencies can be a range of frequencies. In an embodiment herein, for NR, this could be a range of New Radio Absolute Radio Frequency Channel Numbers (NR-ARFCNs). In an embodiment herein, the UE 102 receives a start NR-ARFCN and a number of NR-ARFCNs or a start NR-ARFCN and an end NR-ARFCN from the base station, where the UE 102 is allowed to transmit SR or Random Access for SR during the non-active period of the Cell-DRX.

In an embodiment herein, the network 101 indicates the support of allowing transmission of SR/triggering of RA during the non-active period of Cell-DRX explicitly to the UE 102, via a flag as part of System information message or implicitly by indicating the NES mode (like full sleep state with no transmission and reception during non-active period, partial sleep state supporting only uplink or downlink, partial sleep state with supporting RA/SR access only etc.) as part of broadcasted System Information message. The UE 102 applies the restriction on the SR transmission and/or RA transmission during the cell DRX inactive period based on the indicated sleep mode of the cell, and the SR configuration.

In an embodiment herein, if the UE 102 is configured to allow SR/RA transmission during the non-active period of Cell-DRX, the UE 102 uses the dedicated configuration and overrides the broadcasted indication in System Information, if the cell supports SR/RA transmission during the non-active period of Cell-DRX.

An example RRC configuration message is depicted below that provides the SR configuration including at least one parameter that governs the operation of the pertinent SR transmission and/or the pertinent Random Access procedure in the NES cell. This is described as below in TABLE 1:

TABLE 1
- LogicalChannelConfig
The IE LogicalChannelConfig is used to configure the logical channel parameters.
LogicalChannelConfig information element
-- ASN1START
-- TAG-LOGICALCHANNELCONFIG-START

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, |

kBps128, kBps256, kBps512,
kBps1024, kBps2048, kBps4096, kBps8192, kBps16384,
kBps32768, kBps65536, infinity},

| | |
|---|---|
| bucketSizeDuration | ENUMERATED {ms5, ms10, ms20, ms50, ms100, ms150, |

ms300, ms500, ms1000,

| | |
|---|---|
| | spare7, spare6, spare5, spare4, spare3,spare2, spare1}, |
| allowedServingCells | SEQUENCE (SIZE (1..maxNrofServingCells-1)) OF |

ServCellIndex

OPTIONAL, -- Cond

PDCP-CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, |

ms0p125, ms0p25, ms0p5, ms0p01-v1700, spare1}

OPTIONAL, -- Need

R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | | |
|---|---|---|
| schedulingRequestID | SchedulingRequestId | OPTIONAL, |

-- Need R

| | |
|---|---|
| logicalChannelSR-Mask | BOOLEAN, |

```
    logicalChannelSR-DelayTimerApplied BOOLEAN,
      logicalChannelSR-Allowed-NES BOOLEAN,
      logicalChannelSR-RA-Allowed-NES BOOLEAN,
      logicalChannelSR-RA-CondAllowed-NES BOOLEAN,
```

| | |
|---|---|
| logicalChannelSR-RA-Cond-Duration | ENUMERATED {value1, value2, |

value3,..... }
...,

bitRateQueryProhibitTimer ENUMERATED {s0, s0dot4, s0dot8, s1dot6, s3, s6, s12,

s30} OPTIONAL, -- Need R
[[

| | |
|---|---|
| allowedCG-List-r16 | SEQUENCE (SIZE (0.. |

maxNrofConfiguredGrantConfigMAC-1-r16)) OF ConfiguredGrantConfigIndexMAC-r16

OPTIONAL, -- Need

S

| | |
|---|---|
| allowedPHY-PriorityIndex-r16 | ENUMERATED {p0, p1} |

```
OPTIONAL -- Need S
    ]],
    [[
```

| | |
|---|---|
| logicalChannelGroupIAB-Ext-r17 | INTEGER (0..maxLCG-ID-IAB-r17) |

OPTIONAL, -- Need R

| | |
|---|---|
| allowedHARQ-mode-r17 | ENUMERATED {harqModeA, harqModeB} |

OPTIONAL -- Need R
]]

| | |
|---|---|
| } | OPTIONAL, -- Cond UL |

```
  ...,
  [[
```

| | | |
|---|---|---|
| channelAccessPriority-r16 | INTEGER (1..4) | OPTIONAL, |

-- Need R

| | |
|---|---|
| bitRateMultiplier-r16 | ENUMERATED {x40, x70, x100, x200} |

OPTIONAL -- Need R
]]
}
-- TAG-LOGICALCHANNELCONFIG-STOP
-- ASN1STOP

logicalChannelSR-Allowed-NES Controls SR triggering when a Cell-DRX (and/or a Cell-DTX) is configured and/or is activated in the NES cell. ‘true’ indicates that the pertinent SR is allowed to be transmitted in the non-Active Period of the Cell-DRX (and/or in the non-Active period of the Cell-DTX) for this logical channel as specified in TS 38.321; whereas ‘false’ indicates otherwise.

logicalChannelSR-RA-Allowed-NES controls Random Access procedure triggering due to specific SR triggering, when a Cell-DRX (and/or a Cell-DTX) is configured and/or is activated in the NES cell. ‘true’ indicates that Random Access procedure is triggered, and the preamble is allowed to be transmitted for the pertinent SR in the non-Active Period of the Cell-DRX (and/or in the non-Active period of the Cell-DTX) for this logical channel; whereas ‘false’ indicates otherwise.

logicalChannelSR-RA-CondAllowed-NES controls Random Access procedure triggering due to specific SR triggering when a Cell-DRX (and/or a Cell-DTX) is configured and/or is activated in the NES cell. ‘true’ indicates that Random Access procedure is triggered, and preamble is allowed to be transmitted for the pertinent SR in the non-Active Period of the Cell-DRX (and/or in the non-Active period of the Cell-DTX) for this logical channel if the condition is fulfilled, whereas ‘false’ indicates otherwise. The condition is that the remaining time until the next valid PUCCH occasion for the SR is longer than T (considering delay requirement and given by logicalChannelSR-RA-Cond-Duration field), the UE 102 triggers a Random Access. Time threshold T can be configured by an RRC signaling message from the network 101.

The IE MAC-CellGroupConfig is used to configure MAC parameters for a cell group, including DRX, as below in TABLE 2.

TABLE 2
MAC-CellGroupConfig information element

-- ASNSTART
-- TAG-MAC-CELLGROUPCONFIG-START

| MAC-CellGroupConfig ::= | SEQUENCE { | |
|---|---|---|
| drx-Config | SetupRelease { DRX-Config } | OPTIONAL, |

-- Need M

| | | |
|---|---|---|
| schedulingRequestConfig | SchedulingRequestConfig | OPTIONAL, |

-- Need M

| | | |
|---|---|---|
| bsr-Config | BSR-Config | OPTIONAL, -- |

Need M

| | | |
|---|---|---|
| tag-Config | TAG-Config | OPTIONAL, -- |

Need M

| | | |
|---|---|---|
| phr-Config | SetupRelease { PHR-Config } | OPTIONAL, |

-- Need M

| | |
|---|---|
| skipUplinkTxDynamic | BOOLEAN, |

```
  ...,
  [[
```

| | | |
|---|---|---|
| csi-Mask | BOOLEAN | OPTIONAL, -- |

Need M

| | |
|---|---|
| dataInactivityTimer | SetupRelease { DataInactivityTimer } |

```
OPTIONAL -- Cond MCG-Only
  ]],
  [[
```

| | | |
|---|---|---|
| usePreBSR-r16 | ENUMERATED {true} | OPTIONAL, |

-- Need R

| | |
|---|---|
| schedulingRequestID-LBT-SCell-r16 | SchedulingRequestId |
| OPTIONAL, -- Need R | |
| lch-BasedPrioritization-r16 | ENUMERATED {enabled} |
| OPTIONAL, -- Need R | |
| schedulingRequestID-BFR-SCell-r16 | SchedulingRequestId |

OPTIONAL, -- Need R

| | |
|---|---|
| drx-ConfigSecondaryGroup-r16 | SetupRelease { DRX-ConfigSecondaryGroup-r16 } |

```
OPTIONAL -- Need M
  ]],
  ]]
```

| | |
|---|---|
| enhancedSkipUplinkTxDynamic-r16 | ENUMERATED {true} |

OPTIONAL, -- Need R

| | |
|---|---|
| enhancedSkipUplinkTxConfigured-r16 | ENUMERATED {true} |

```
OPTIONAL -- Need R
  ]],
  [[
```

| | | |
|---|---|---|
| intraCG-Prioritization-r17 | ENUMERATED {enabled} | OPTIONAL, - |

- Cond LCH-PrioWithReTxTimer

| | | |
|---|---|---|
| drx-ConfigSL-r17 | SetupRelease { DRX-ConfigSL-r17 } | OPTIONAL, - |

- Need M

| | | |
|---|---|---|
| drx-ConfigExt-v1700 | SetupRelease { DRX-ConfigExt-v1700 } | OPTIONAL, |

-- Need M

| | | |
|---|---|---|
| schedulingRequestID-BFR-r17 | SchedulingRequestId | OPTIONAL, -- |

Need R

| | | |
|---|---|---|
| schedulingRequestID-BFR2-r17 | SchedulingRequestId | OPTIONAL, - |

- Need R

| | | |
|---|---|---|
| schedulingRequestConfig-v1700 | SchedulingRequestConfig-v1700 | OPTIONAL, |

-- Need M

| | |
|---|---|
| schedulingRequestID-BFR-AllowedNES-r18 | SchedulingRequestId |

OPTIONAL, -- Need R

| | |
|---|---|
| schedulingRequestID-BFR2-AllowedNES-r18 | SchedulingRequestId |

OPTIONAL, -- Need R

| | |
|---|---|
| schedulingRequestConfig-v1800 | SchedulingRequestConfig-v1800 |

OPTIONAL, -- Need M

| | | |
|---|---|---|
| tar-Config-r17 | SetupRelease { TAR-Config-r17 } | OPTIONAL, |

```
-- Need M
  g-RNTI-ConfigToAddModList-r17 SEQUENCE (SIZE (1..maxG-RNTI-r17)) OF MBS-
RNTI-SpecificConfig-r17 OPTIONAL, -- Need N
  g-RNTI-ConfigToReleaseList-r17 SEQUENCE (SIZE (1..maxG-RNTI-r17)) OF MBS-
RNTI-SpecificConfigId-r17 OPTIONAL, -- Need N
  g-CS-RNTI-ConfigToAddModList-r17 SEQUENCE (SIZE (1..maxG-CS-RNTI-r17)) OF
MBS-RNTI-SpecificConfig-r17 OPTIONAL, -- Need N
  g-CS-RNTI-ConfigToReleaseList-r17 SEQUENCE (SIZE (1..maxG-CS-RNTI-r17)) OF
MBS-RNTI-SpecificConfigId-r17 OPTIONAL, -- Need N
```

| | |
|---|---|
| allowCSI-SRS-Tx-MulticastDRX-Active-r17 | BOOLEAN |

```
OPTIONAL -- Need M
  ]],
  [[
```

| | |
|---|---|
| schedulingRequestID-PosMG-Request-r17 | SchedulingRequestId |

OPTIONAL, -- Need R

| | |
|---|---|
| drx-LastTransmissionUL-r17 | ENUMERATED {enabled} |

OPTIONAL -- Need R
]]
}

| | |
|---|---|
| DataInactivityTimer ::= | ENUMERATED {s1, s2, s3, s5, s7, s10, s15, s20, s40, s50, s60, |

s80, s100, s120, s150, s180}

| | |
|---|---|
| MBS-RNTI-SpecificConfig-r17 ::= | SEQUENCE { |
| mbs-RNTI-SpecificConfigId-r17 | MBS-RNTI-SpecificConfigId-r17, |
| groupCommon-RNTI-r17 | CHOICE { |
| g-RNTI | RNTI-Value, |
| g-CS-RNTI | RNTI-Value |

},

| | |
|---|---|
| drx-ConfigPTM-r17 | SetupRelease { DRX-ConfigPTM-r17 } |

OPTIONAL, -- Need M

| | |
|---|---|
| harq-FeedbackEnablerMulticast-r17 | ENUMERATED {dci-enabler, enabled} |

OPTIONAL, -- Need S

| | |
|---|---|
| harq-FeedbackOptionMulticast-r17 | ENUMERATED {ack-nack, nack-only} |

OPTIONAL, -- Cond HARQFeedback

| | |
|---|---|
| pdsch-AggregationFactor-r17 | ENUMERATED {n2, n4, n8} |

OPTIONAL -- Cond G-RNTI
}
MBS-RNTI-SpecificConfigId-r17 ::= INTEGER (0..maxG-RNTI-1-r17)
-- TAG-MAC-CELLGROUPCONFIG-STOP
-- ASN1STOP

schedulingRequestID-BFR-allowed-NES Indicates whether it is allowed to transmit in the NES cell in the non-Active Period of the Cell-DRX (and/or in the non-Active Period of the Cell-DTX) the SR for the scheduling request configuration (SchedulingRequestConfig) that the UE shall use upon detecting a beam failure on the detection resources configured in failureDetectionSet1 of a serving cell while beam failure is not detected on resources configured in failureDetectionSet2 of the same serving cell.

schedulingRequestID-BFR2 indicates whether it is allowed to transmit in the NES cell in the non-Active Period of the Cell-DRX (and/or in the non-Active Period of the Cell-DTX) the SR the scheduling request configuration (SchedulingRequestConfig) that the UE shall use upon detecting a beam failure on the detection resources configured in failureDetectionSet2 of a serving cell while beam failure is not detected on resources configured in failureDetectionSet1 of the same serving cell.

The IE SchedulingRequestConfig is used to configure the parameters, for the dedicated scheduling request (SR) resources, as below in table 3.

TABLE 3
SchedulingRequestConfig information element

-- ASN1START
-- TAG-SCHEDULINGREQUESTCONFIG-START

| | |
|---|---|
| SchedulingRequestConfig ::= | SEQUENCE { |
| schedulingRequestToAddModList | SEQUENCE (SIZE (1..maxNrofSR- |

ConfigPerCellGroup)) OF SchedulingRequestToAddMod

| | |
|---|---|
| | OPTIONAL, -- Need N |
| schedulingRequestToReleaseList | SEQUENCE (SIZE (1..maxNrofSR- |

ConfigPerCellGroup)) OF SchedulingRequestId

| | |
|---|---|
| | OPTIONAL -- Need N |
| } | |
| SchedulingRequestToAddMod ::= | SEQUENCE { |
| schedulingRequestId | SchedulingRequestId, |
| sr-ProhibitTimer | ENUMERATED {ms1, ms2, ms4, ms8, ms16, ms32, ms64, |

ms128} OPTIONAL, -- Need S

| | |
|---|---|
| sr-TransMax | ENUMERATED { n4, n8, n16, n32, n64, spare3, spare2, |

spare1}
}

| | |
|---|---|
| SchedulingRequestConfig-v1700 ::= | SEQUENCE { |
| schedulingRequestToAddModListExt-v1700 | SEQUENCE (SIZE (1..maxNrofSR- |

ConfigPerCellGroup)) OF SchedulingRequestToAddModExt-v1700

OPTIONAL -- Need N

}

| | |
|---|---|
| SchedulingRequestToAddModExt-v1700 ::= SEQUENCE { | |
| sr-ProhibitTimer-v1700 | ENUMERATED { ms192, ms256, ms320, ms384, ms448, |

ms512, ms576, ms640, ms1082, spare7, spare6, spare5, spare4, spare3, spare2, spare1}

OPTIONAL -- Need R

}

| | |
|---|---|
| SchedulingRequestConfig-v1800 ::= | SEQUENCE { |
| schedulingRequestToAddModListExt-v1800 | SEQUENCE (SIZE (1..maxNrofSR- |

ConfigPerCellGroup)) OF SchedulingRequestToAddModExt-v1800

OPTIONAL -- Need N

}
SchedulingRequestToAddModExt-v1800 ::= SEQUENCE {

| | |
|---|---|
| sr-Allowed-NES-v1800 | BOOLEAN |
| ra-Allowed-NES | BOOLEAN, |
| ra-CondAllowed-NES | BOOLEAN, |
| ra-Cond-Duration | ENUMERATED {value1, value2, value3,..... } |

}
-- TAG-SCHEDULINGREQUESTCONFIG-STOP
-- ASN1STOP

sr-Allowed-NES controls specific SR transmission on PUCCH when NES cell is in the non-Active Period of the Cell-DRX (and/or in the non-Active Period of the Cell-DTX). ‘true’ indicates that the pertinent SR is allowed to be transmitted in the non-Active Period of the Cell-DRX (and/or in the non-Active period of the Cell-DTX), whereas ‘false’ indicates otherwise.

ra-Allowed-NES controls Random Access procedure triggering due to specific SR triggering when a Cell-DRX (and/or a Cell-DTX) is configured and/or is activated in the NES cell. ‘true’ indicates that Random Access procedure is triggered, and preamble is allowed to be transmitted for the pertinent SR in the non-Active Period of the Cell-DRX (and/or in the non-Active period of the Cell-DTX) for this logical channel, whereas ‘false’ indicates otherwise.

ra-CondAllowed-NES controls Random Access procedure triggering due to specific SR triggering, when a Cell-DRX (and/or a Cell-DTX) is configured and/or is activated in the NES cell. ‘true’ indicates that Random Access procedure is triggered, and the preamble is allowed to be transmitted for the pertinent SR in the non-Active Period of the Cell-DRX (and/or in the non-Active period of the Cell-DTX) if the condition is fulfilled, whereas ‘false’ indicates otherwise. The condition is that the remaining time until the next valid PUCCH occasion for the SR is longer than T (considering delay requirement and given by ra-Cond-Duration field), the UE triggers a Random Access. Time threshold T can be configured by an RRC signaling message from the network.

Embodiments herein use the terms ‘active state/non-active state’, ‘active period/non-active period’, ‘active stage/non-active stage’, ‘active time’/non-active time’, and so on, interchangeably to refer to the active period/non-active period, without any loss of interpretation or usage.

FIG. 7 illustrates a block diagram of a terminal (or a user equipment (UE)), according to embodiments of the present disclosure.

As shown in FIG. 7, a terminal according to an embodiment may include a transceiver 710, a memory 720, and a processor (or a controller) 730. The transceiver 710, the memory 720, and the processor (or controller) 730 of the terminal may operate according to a communication method of the terminal described above. However, the components of the terminal are not limited thereto. For example, the terminal may include more or fewer components than those described in FIG. 7. In addition, the processor (or controller) 730, the transceiver 710, and the memory 720 may be implemented as a single chip. Also, the processor (or controller) 730 may include at least one processor.

The transceiver 710 collectively refers to a terminal station receiver and a terminal transmitter, and may transmit/receive a signal to/from a base station or another terminal. The signal transmitted or received to or from the terminal may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor (or controller) 730, a signal through a wireless channel, and transmit a signal output from the processor (or controller) 730 through the wireless channel.

The memory 720 may store a program and data required for operations of the terminal. Also, the memory 720 may store control information or data included in a signal obtained by the terminal. The memory 720 may be a storage medium, such as read-only memory (ROM), random access memory (RAM), a hard disk, a CD-ROM, and a DVD, or a combination of storage media.

The processor (or controller) 730 may control a series of processes such that the terminal operates as described above. For example, the processor (or controller) 730 may receive a data signal and/or a control signal, and the processor (or controller) 730 may determine a result of receiving the signal transmitted by the base station and/or the other terminal.

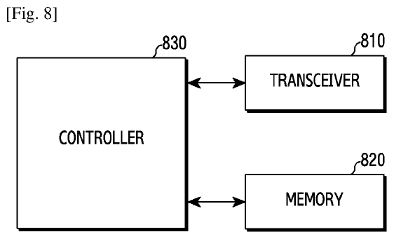

FIG. 8 illustrates a block diagram of a base station, according to embodiments of the present disclosure.

As shown in FIG. 8, the base station of the present disclosure may include a transceiver 810, a memory 820, and a processor (or, a controller) 830. The transceiver 810, the memory 820, and the processor (or controller) 830 of the base station may operate according to a communication method of the base station described above. However, the components of the base station are not limited thereto. For example, the base station may include more or fewer components than those described in FIG. 8. In addition, the processor (or controller) 830, the transceiver 810, and the memory 820 may be implemented as a single chip. Also, the processor (or controller) 830 may include at least one processor.

The transceiver 810 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor (or controller) 830, a signal through a wireless channel, and transmit a signal output from the processor (or controller) 830 through the wireless channel.

The memory 820 may store a program and data required for operations of the base station. Also, the memory 820 may store control information or data included in a signal obtained by the base station. The memory 820 may be a storage medium, such as ROM, RAM, a hard disk, a CD-ROM, and a DVD, or a combination of storage media.

The processor (or controller) 830 may control a series of processes such that the base station operates as described above. For example, the processor (or controller) 830 may receive a data signal and/or a control signal, and the processor (or controller) 830 may determine a result of receiving the signal transmitted by the terminal and/or the core network function.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The embodiments disclosed herein can be implemented through at least one software program running on at least one hardware device and performing network management functions to control the network elements. The elements include blocks which can be at least one of a hardware device, or a combination of hardware device and software module.

The embodiment disclosed herein describes methods and systems for configuring Scheduling Requests (SR) for Network Energy Saving (NES), wherein existing SR procedures for the UE are enhanced to enable a graceful co-existence with NES approaches as employed by the network nodes. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The above description is only an exemplary implementation of the present invention, and is not intended to limit the scope of protection of the present invention, which is determined by the appended claims.

According to an embodiment of the disclosure, a method for configuring scheduling requests (SR) for Network Energy Savings (NES) in a wireless communication network, the method comprising: determining, if the UE is not in a non-active period of at least one configured and activated cell-DRX configuration in a serving cell; and initiating, by a User Equipment (UE), transmission of the SR,

According to another embodiment of the disclosure, the method comprises: not transmitting, by the UE, the SR, if the UE is in the non-active period of the configured and activated cell-DRX configuration; and transmitting, by the UE, the SR in a valid Physical Uplink Control Channel (PUCCH), upon the UE coming out of the non-active period of the configured and activated cell-DRX configuration.

According to another embodiment of the disclosure, the method comprises transmitting, by the UE, one of the SR, or a pertinent Random Access (RA) if the UE is in the non-active period of the configured and activated cell-DRX configuration, based on at least one of type of the SR; priority of a service to which the SR corresponds; latency of the service; criticality of the service; and priority of at least one of a Logical channel Group (LCG), a Logical Channel, and a SR configuration to which the SR corresponds.

According to another embodiment of the disclosure, wherein the type of the SR, and the pertinent RA is specified in 3rd Generation Partnership (3GPP) specification.

According to another embodiment of the disclosure, the method comprises determining, by the UE, that the SR can be transmitted, or that the RA can be triggered in the non-active period of the configured and activated cell-DRX configuration, if configured for the UE in at least one of: a Radio Resource Control (RRC) signalling by the wireless communication network for a specific SR configuration; a flag as part of a System information message; and implicitly indicating by the NES mode indication as part of a system information message.

According to another embodiment of the disclosure, the method comprises: indicating, by the wireless communication network, the activation and/or deactivation of at least one cell-DRX configuration, and at least one cell-DTX configuration to the UE, in at least one of a group common Downlink Control Information (DCI) signaling, and a Medium Access Control (MAC) Control Element (CE); receiving, by the UE, the indication from the wireless communication network in at least one of the group common DCI signaling, and the MAC CE; and activating and/or deactivating, by the UE, at least one cell-DRX configuration, and at least one cell-DTX configuration, based on the indication received from the wireless communication network.

According to another embodiment of the disclosure, wherein the NES mode indication comprises at least one of a full sleep state with no transmission and reception during the non-active period of the configured and activated cell-DRX configuration, a partial sleep state supporting only uplink or downlink, and a partial sleep state with supporting RA/SR access only.

According to another embodiment of the disclosure, the method comprises: initiating, by the UE, a RA procedure on a SpCell, if there is no valid Physical Uplink Control Channel (PUCCH) configured for the SR, and the UE is in the non-active period of the configured and activated cell-DRX configuration; and cancelling, by the UE, a pending SR, on initiating the RA procedure.

According to another embodiment of the disclosure, the method comprises triggering, by the UE, the RA, if a service to which the RA, or pertinent SR corresponds is an emergency service, irrespective of the active period, or the non-active period of the configured and activated cell-DRX configuration.

According to an embodiment of the disclosure, a User Equipment (UE) comprising: a processor; a memory; and a communication module, wherein the processor is coupled with the memory, and the communication module, and is configured to: initiate transmission of a scheduling requests (SR) for Network Energy Savings (NES) in a serving cell, if the UE is not in a non-active period of a configured and activated cell-DRX configuration.

According to another embodiment of the disclosure, wherein the processor is configured to: not transmit the SR, if the UE is in the non-active period of the configured and activated cell-DRX configuration; and transmit the SR in a valid Physical Uplink Control Channel (PUCCH), upon the UE coming out of the non-active period of the configured and activated cell-DRX configuration.

According to another embodiment of the disclosure, wherein the processor is configured to: transmit one of the SR, or a pertinent Random Access (RA), if the UE is in the non-active period of the configured and activated cell-DRX configuration, based on at least one of type of the SR; priority of a service to which the SR corresponds; latency of the service; criticality of service; and priority of at least one of a Logical channel Group (LCG), a Logical Channel, and a SR configuration to which the SR corresponds.

According to another embodiment of the disclosure, wherein the type of the SR, and the pertinent RA is specified in 3rd Generation Partnership (3GPP) specifications.

According to another embodiment of the disclosure, wherein the processor is configured to determine that the SR can be transmitted, or that the RA can be triggered in the non-active period of the configured and activated cell-DRX configuration, if configured for the UE in at least one of: a Radio Resource Control (RRC) signalling by the wireless communication network for a specific SR configuration; a flag as part of a System information message; and implicitly indicating by the NES mode indication as part of a system information message, in at least one of a common L1/L2 signaling, and a Medium Access Control (MAC) Control Element (CE).

According to another embodiment of the disclosure, wherein the processor is configured to activate and/or deactivate at least one cell-DRX configuration, and at least one cell-DTX configuration, on receiving an indication from the wireless communication network in at least one of a group common Downlink Control Information (DCI) signaling, and a Medium Access Control (MAC) Control Element (CE).

According to another embodiment of the disclosure, wherein the NES mode indication comprises at least one of a full sleep state with no transmission and reception during the non-active period of the configured and activated cell-DRX configuration, a partial sleep state supporting only uplink or downlink, and a partial sleep state with supporting RA/SR access only.

According to another embodiment of the disclosure, wherein the processor is configured to: initiate a RA procedure on a SpCell, if there is no valid Physical Uplink Control Channel (PUCCH) configured for the SR, and the UE is in the non-active period of the configured and activated cell-DRX configuration; and cancel a pending SR, on initiating the RA procedure.

According to another embodiment of the disclosure, wherein the processor is configured to trigger the RA, if a service to which the RA, or pertinent SR corresponds is an emergency service, irrespective of the active period, or the non-active period of the configured and activated cell-DRX configuration.

According to another embodiment of the disclosure, a wireless communication network configured to: indicate activation and/or deactivation of at least one cell-DRX configuration, and at least one cell-DTX configuration to a User Equipment (UE), in at least one of a group common Downlink Control Information (DCI) signaling, and a Medium Access Control (MAC) Control Element (CE).

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1-15. (canceled)

16. A method performed by a user equipment (UE) in a wireless communication system, the method comprising:
identifying that a cell discontinuous reception (DRX) is configured and is activated for a serving cell; and
identifying whether the serving cell is in a cell DRX non-active period,
wherein, in case that the serving cell is in the cell DRX non-active period:
a scheduling request (SR) is not transmitted, an SR counter is not incremented, and an SR prohibit timer is not started, and
a random access is initiated for a service of a specific type.

17. The method of claim 16, wherein the cell DRX is activated in case that downlink control information indicating an activation of the cell DRX is received.

18. The method of claim 16, wherein the cell DRX is activated based on an indication from a lower layer.

19. The method of claim 16,
wherein the SR is kept as pending and is delayed until a cell DRX active period, and
wherein the SR is transmitted on a valid physical uplink control channel (PUCCH) resource in the cell DRX active period.

20. The method of claim 16,
wherein a specific SR is configured as allowed during the cell DRX non-active period, and
wherein the specific SR is identified based on at least one of a type of SR, a priority of service, a latency of service, or a priority of logical channel.

21. The method of claim 16,
wherein a support of allowing an SR transmission during the cell DRX non-active period is indicated via system information, or
wherein the support of allowing the SR transmission during the cell DRX non-active period is implicitly indicated in a network energy saving (NES) mode, and a restriction on the SR transmission during the cell DRX non-active period is based on the NES mode.

22. The method of claim 16, wherein the service of the specific type comprises an emergency service.

23. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
identify that a cell discontinuous reception (DRX) is configured and is activated for a serving cell, and
identify whether the serving cell is in a cell DRX non-active period,
wherein, in case that the serving cell is in the cell DRX non-active period:
a scheduling request (SR) is not transmitted, an SR counter is not incremented, and an SR prohibit timer is not started, and
a random access is initiated for a service of a specific type.

24. The UE of claim 23, wherein the cell DRX is activated in case that downlink control information indicating an activation of the cell DRX is received.

25. The UE of claim 23, wherein the cell DRX is activated based on an indication from a lower layer.

26. The UE of claim 23,
wherein the SR is kept as pending and is delayed until a cell DRX active period, and
wherein the SR is transmitted on a valid physical uplink control channel (PUCCH) resource in the cell DRX active period.

27. The UE of claim 23,
wherein a specific SR is configured as allowed during the cell DRX non-active period, and
wherein the specific SR is identified based on at least one of a type of SR, a priority of service, a latency of service, or a priority of logical channel.

28. The UE of claim 23, wherein a support of allowing an SR transmission during the cell DRX non-active period is indicated via system information.

29. The UE of claim 23, wherein a support of allowing an SR transmission during the cell DRX non-active period is implicitly indicated in a network energy saving (NES) mode, and a restriction on the SR transmission during the cell DRX non-active period is based on the NES mode.

30. The UE of claim 23, wherein the service of the specific type comprises an emergency service.
